(19) United States
(12) Patent Application Publication
(10) Pub. No.: US 2010/0274840 A1
(43) Pub. Date: Oct. 28, 2010

(54) COOPERATION APPARATUS USING PEER-TO-PEER AND METHOD THEREOF

(75) Inventors: Kyong I Ku, Gyunggi-do (KR); Moon Young Chung, Daejeon (KR); Won Young Kim, Daejeon (KR); Wan Choi, Daejeon (KR)

Correspondence Address: LOWE HAUPTMAN HAM & BERNER, LLP, 1700 DIAGONAL ROAD, SUITE 300, ALEXANDRIA, VA, 22314, US

(73) Assignee: ELECTRONICS AND TELECOMMUNICATIONS RESEARCH INSTITUTE, DAEJEON (KR)

(21) Appl. No.: 12/515,180

(22) PCT Filed: Dec. 4, 2007
(86) PCT No.: PCT/KR07/06243

§ 371 Date: May 15, 2009

(30) Foreign Application Priority Data
Dec. 4, 2006 (KR) 10-2006-0121314
Oct. 23, 2007 (KR) 10-2007-0106515

(51) Int. Cl. G06F 15/16

(52) U.S. Cl. 709/203; 709/204

(57) ABSTRACT

Cooperation system and method using a peer-to-peer (P2P) protocol are provided. A terminal performing a cooperation process through the P2P protocol, includes: a cooperation control unit including a cooperation relation list, requesting a different terminal or terminal group to cooperate with the terminal with reference to the cooperation relation list when a cooperation process is requested, restoring an application context transmitted from the different terminal or terminal group, extracts an application context of the terminal when receiving a cooperation request, and providing the application context of the terminal to the different terminal or terminal group; an application cooperation execution unit cooperating with the different terminal or terminal group for the application based on the application context restored by the cooperation control unit; and a P2P communication unit transmitting and receiving the application context in a P2P manner by accessing the different terminal or terminal group. Accordingly, it is possible to cooperate with more terminals or terminal groups and prevent disconnection of the cooperation process.

### TECHNICAL FIELD

The present invention relates to cooperation system and method, and more particularly, to cooperation system and method using a peer-to-peer (P2P) protocol.

The work was supported by the IT R&D program of MIC/IITA [2005-S-007-02, A Development of Open Software Based On-Demand Officeware Deployment Technologies].

### BACKGROUND ART

A cooperation system performs a series of real time tasks for allowing common applications (application software such as an application, a document editor, a presentation application, a spreadsheet, a web browser which is widely used in home or office) to be shared and commonly performed among remote terminals.

In general, the cooperation system has a server-client structure. The server stores position information of user terminals, connects a communication session between user terminals based on the position information, and supports a document cooperation process, whenever a specific user terminal requests a cooperation process with another user terminal.

### DISCLOSURE OF INVENTION

### Technical Problem

Since a server has to connect communication sessions among all the user terminals and has to relay data needed for a cooperation process, the number of cooperating terminals is limited due to a limit of capacity of the server.

In addition, since the relay of data is not smoothly performed based on the cooperation status and the operation status of the server, the cooperation process is frequently disconnected.

### Technical Solution

According to an aspect of the present invention, there is provided a terminal performing a cooperation process through a peer-to-peer (P2P) protocol, the terminal comprising: a cooperation control unit including a cooperation relation list, requesting a different terminal or terminal group to cooperate with the terminal with reference to the cooperation relation list when a cooperation process is requested, restoring an application context transmitted from the different terminal or terminal group, extracts an application context of the terminal when receiving a cooperation request, and providing the application context of the terminal to the different terminal or terminal group; an application cooperation execution unit cooperating with the different terminal or terminal group for the application based on the application context restored by the cooperation control unit; and a P2P communication unit transmitting and receiving the application context in a P2P manner by accessing the different terminal or terminal group.

In the above aspect of the present invention, the cooperation relation list may include information on the different terminal or terminal group having the cooperation relation and information on the application list, and the application context may be operation status information of the application for which the cooperation process is performed.

In addition, the cooperation control unit may further have a function of extracting the application context of the terminal and providing the application context to the different terminal or terminal group so that the different terminal or terminal group recognizes a progress of the cooperation process, even when the terminal requests the cooperation process.

According to another aspect of the present invention, there is provided a coordination server connected to a plurality of terminals for performing a cooperation process, the coordination server comprising: a terminal communication unit communicating with the plurality of terminals through a P2P protocol; a session management unit determining whether the plurality of terminals log in the coordination server and connecting a communication session with the logged-in terminals; and a cooperation management unit managing a cooperation relation list and providing the cooperation relation list to the logged-in terminals.

In the above aspect of the present invention, the cooperation relation list may include information on the terminal or terminal group having a cooperation relation with the terminal and information on an application list.

In addition, the coordination server may further comprise an application context providing unit receiving and storing the application context transmitted from terminals that performs the cooperation process when there is a terminal that logs out the coordination server and providing the application context when the logged-out terminal logs in the coordination server, again.

According to another aspect of the present invention, there is provided a method of requesting a cooperation process using a P2P protocol in a cooperation system constructed with a coordination server and a plurality of terminals that performs the cooperation process, the method comprising: allowing a terminal to request a different terminal or terminal group to cooperate with the terminal with reference to a cooperation relation list; allowing the different terminal or terminal group to receive the application context provided in a P2P manner by accepting the cooperation request; and performing the cooperation process of the application by restoring the received application context.

In the above aspect of the present invention, the cooperation relation list may include information on the different terminal or terminal group having a cooperation relation and information on the application list, and the application context may be operation status information of an application for which the cooperation process is performed.

According to another aspect of the present invention, there is provided a method of accepting a cooperation request using a P2P protocol in a cooperation system constructed with a plurality of terminals that performs a cooperation process, the method comprising: allowing a terminal to determine whether to accept the cooperation request, when receiving the cooperation request from a different terminal or terminal group; and allowing the terminal to extract an application context of its own when accepting the cooperation request and provide the application context to the different terminal or terminal group in a P2P manner.

In the above aspect of the present invention, the cooperation relation list may include information on the different terminal or terminal group having a cooperation relation and information on the application list, and the application context may be operation status information of an application for which the cooperation process is performed.

In addition, the method of accepting the cooperation request using the P2P protocol may further comprise at least one of the group consisting of: storing the application context when the terminal or a part of the terminal group that performs the cooperation application is disconnected and providing the application context when the logged-out terminal or part of the terminal group logs in the coordination server, again; setting priorities of the cooperation relation of the different terminal or terminal group and firstly extracting and providing the application context, when the different terminal or terminal group having a high priority request the cooperation process; and setting priorities of the cooperation relation of the different terminal or terminal group and firstly extracting and providing the application context when the different terminal or terminal group having the high priority logs in the coordination server and cooperating by allowing the transmitter to directly access the different terminal or terminal group and restore the application context.

### ADVANTAGEOUS EFFECTS

According to the present invention, in cooperation system and method using a peer-to-peer (P2P) protocol, terminals or terminal groups transmit and receive an application context used for a cooperation process and restore the application context by using the P2P protocol. On the other hand, a coordination server manages and provides a cooperation relation list and checks whether each terminal logs in the coordination server.

The terminals or terminal groups can perform the cooperation process with a larger number of terminals or terminal groups based on P2P characteristics. The speed of transmitting and receiving the application context and the speed of restoring the application context increases, thereby preventing disconnection of the cooperation process.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a configuration of a cooperation system according to an embodiment of the present invention;

FIG. 2 illustrates detailed structures of a terminal and a coordination server according to an embodiment of the present invention;

FIG. 3 is a flowchart of a method of requesting a cooperation process using a peer-to-peer (P2P) protocol according to an embodiment of the present invention;

FIG. 4 is a flowchart of a method of accepting a cooperation request using a P2P protocol according to an embodiment of the present invention; and

FIG. 5 is a flowchart of a method of cooperating using a P2P protocol among a plurality of terminals which access a coordination server according to an embodiment of the present invention.

### BEST MODE FOR CARRYING OUT THE INVENTION

Exemplary embodiments of the present invention will now be described in detail with reference to the accompanying drawings. When it is determined that the detailed descriptions of the known techniques or structures related to the present invention depart from the scope of the invention, the detailed descriptions will be omitted.

Like reference numerals designates like elements throughout the specification.

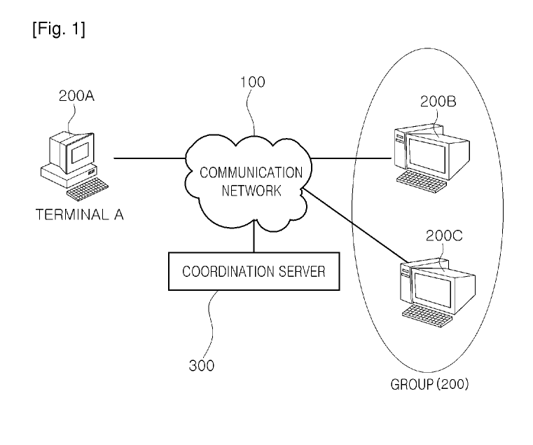

FIG. 1 illustrates a configuration of a cooperation system according to an embodiment of the present invention

Referring to FIG. 1, the cooperation system according to the embodiment of the present invention includes terminals 200A to 200C and a coordination server 300. The terminals 200A to 200C are connected to one another, or the terminals 200A to 200C are connected to the coordination server 300 through a communication network 100.

At this time, the communication network 100 includes wired and wireless internet networks. The communication network 100 includes all the communication lines and networks through which the coordination server 300 can communicate with terminals 200A to 200C.

Predetermined terminals (for example, 200B and 200C) may be represented as a group 200 based on properties of the terminals.

Hereinafter, functions of each component will be described as follows.

Each of the terminals 200A to 200C transmits and receives an application context to and from a different terminal or terminal group in a P2P manner, restores the application context, and cooperates with the different terminal or terminal group.

That is, when a terminal executes an application and needs to cooperate with a different terminal or terminal group, the terminal requests the different terminal or terminal group having a cooperation relation with the terminal for the application to cooperate with the terminal. The terminal receives the application context transmitted in a P2P manner in response to the request, restores the application context, and cooperates with the different terminal or terminal group.

In addition, when the different terminal or terminal group requests the terminal to cooperate with the different terminal or terminal group, the terminal extracts a context of an application for which the terminal is requested to cooperate and transmits the context in the P2P manner.

The coordination server 300 manages a cooperation relation list. When each of the terminals 200A to 200C logs in the coordination server 300, the coordination server 300 provides the cooperation relation list to the logged-in terminal.

In the embodiment of the present invention, the application may be various application software programs such as a document editor, a presentation application, a spread sheet, and a web browser, which are widely used in home or office.

The application context is status information on an operation of the application for which the terminal is requested to cooperate. Examples of the application context include a working document file and a working page position. In case of a web browser, the application context includes a reading internet page, a reading page position, bookmarks, and a read address list.

The cooperation relation list stores information on terminals or terminal groups having a cooperation relation and an application list for each terminal.

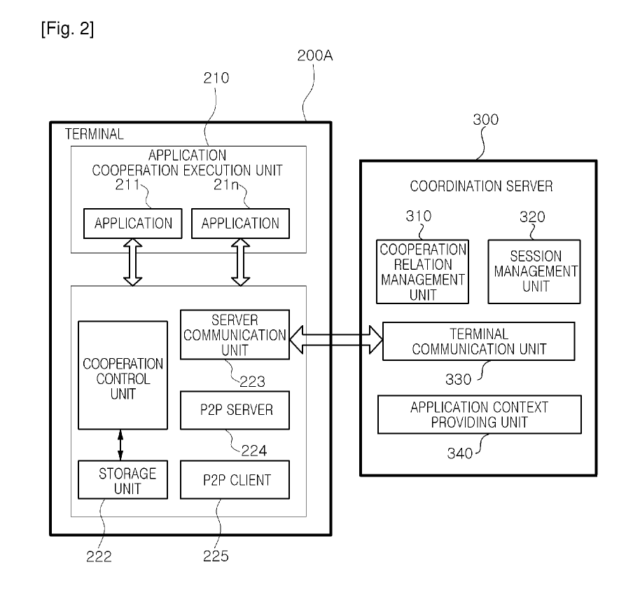

FIG. 2 illustrates detailed structures of a terminal and a coordination server according to an embodiment of the present invention.

Referring to FIG. 2, the terminal 200A includes an application cooperation execution unit 210, a cooperation control unit 221, a storage unit 222, a server communication unit 223, a P2P server 224, and a P2P client 225. The coordination server 300 includes a cooperation relation management unit 310, a session management unit 320, a terminal communication unit 330, and an application context providing unit 340.

The application cooperation execution unit 210 includes one or more applications 211 to 21n and executes each of the applications 211 to 21n. When a user requests a cooperation process for a predetermined application, the application cooperation execution unit 210 receives the application context restored through the cooperation control unit 221 and cooperates for the application.

The cooperation control unit 221 of the terminal 200A logs in the coordination server 300 and receives and stores a cooperation relation list. When the cooperation process is requested, the cooperation control unit 221 recognizes the different terminal or terminal group having a cooperation relation with the terminal 200A with reference to the cooperation relation list, requests the terminal or terminal group to cooperate, and restores the application context received in response to the request. On the contrary, when receiving a cooperation request, the cooperation control unit 221 recognizes an application for which the terminal 200A is requested to cooperate with the terminal or terminal group and provides the context of the application to the requesting terminal or terminal group through a P2P server 224.

If necessary, the cooperation control unit 221 extracts the application context for representing a cooperation status of the terminal 200A even when the terminal 200A requests the terminal or terminal group to cooperate and provides the application context to the terminal or terminal group having the cooperation relation with the terminal 200A. The terminal or terminal group which receives the cooperation request performs the cooperation process in addition to the requesting terminal or terminal group.

When receiving the cooperation request and when the requesting terminal or part of the terminal group logs out the coordination server 300, the cooperation control unit 221 stores the application context in the storage unit 222 or the coordination server 300 and transmits the application context again, when the terminal or part of the terminal group logs in the coordination server 300.

In addition, the cooperation control unit 221 changes a cooperation method based on the cooperation relation. That is, when a terminal or terminal group having a specific cooperation relation requests a cooperation process, the cooperation control unit 221 unconditionally extracts the application context of the terminal 200A and provides the extracted application context. Alternatively, when a terminal or terminal group having a specific cooperation relation logs in the coordination server 300, the cooperation control unit 221 unconditionally extracts the application context of the terminal 200A and provides the extracted application context. Then, a transmitter directly accesses the terminal or terminal group, restores the application context, and performs the cooperation process.

The storage unit 222 of the terminal 200A temporarily stores the application context restored through the cooperation control unit 221 or the extracted application context.

The server communication unit 223 of the terminal 200A communicates with the coordination server by using a P2P protocol. Specifically, the server communication unit 223 receives the cooperation relation list transmitted from the coordination server 300 and transmits the cooperation relation list to the cooperation control unit 221.

When receiving a cooperation request, the P2P server 224 of the terminal 200A provides the application context extracted by the cooperation control unit 221 to the P2P client 225 of the second terminal in the P2P manner.

When requesting a cooperation process, the P2P client 225 of the terminal 200A receives the application context transmitted from the terminal or terminal group in the P2P manner and transmits the application context to the cooperation control unit 221.

The terminal according to the embodiment of the present invention includes the P2P server 224 and the P2P client 225 so as to request the cooperation process and receive the cooperation request.

The cooperation relation management unit 310 of the coordination server 300 provides a cooperation relation list to the terminal that logs in the coordination server 300, while constructing and managing the cooperation relation list by checking the cooperation relation among terminals.

The session management unit 320 of the coordination server 300 connects a communication session with terminals that log in the coordination server 300.

The terminal communication unit 330 of the coordination server 300 communicates with a terminal that logs in the coordination server 300 by using the P2P protocol. Specifically, when a terminal logs in the coordination server 300, the terminal communication unit 330 provides the cooperation relation list provided by the cooperation relation management unit 310.

When the requesting terminal or part of the terminal group log out the coordination server 300, the application context providing unit 340 of the coordination server 300 temporarily stores the application context transmitted from the receiving terminal or terminal group and provides the application context, when the requesting terminal or part of the terminal group logs in the coordination server 300.

Although only the terminal 200A is described in FIG. 2, the other terminals 200B and 200C operate like the terminal 200A.

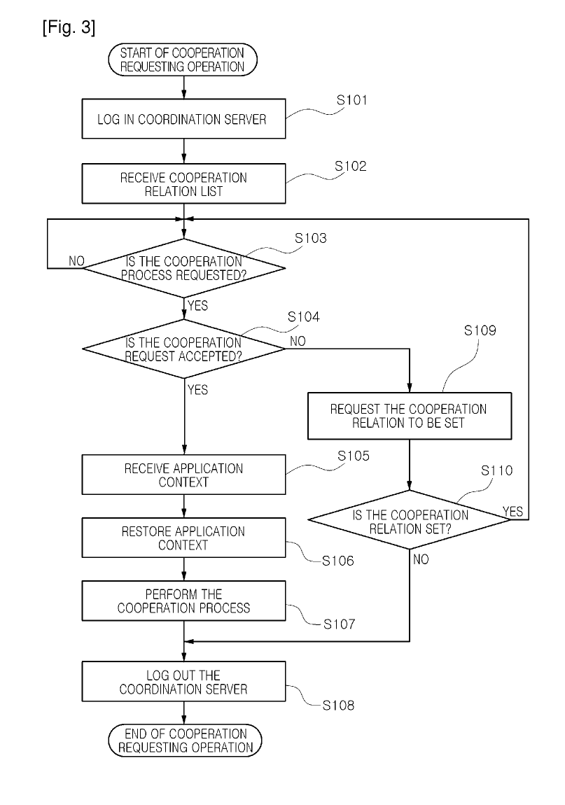

FIG. 3 is a flowchart of a method of requesting a cooperation process using a P2P protocol according to an embodiment of the present invention.

First, the terminal 200A logs in the coordination server 300 (operation 5101) and receives a cooperation relation list (operation S102).

In this state, when a user of the terminal 200A requests a cooperation process for a specific application, the terminal 200A recognizes the different terminal or terminal group having a cooperation relation to the terminal 200A with reference to the cooperation relation list and requests the cooperation process for the application (operation S103).

When the different terminal or terminal group accepts the cooperation request (operation S104) and transmits the application context in the P2P manner, the application context is received and restored (operations S105 and S106).

The cooperation process of the application is performed based on the restored application (operation S107).

In operation S107, the cooperation process of the application is performed based on the restored application, the application context of the terminal is transmitted to the requesting terminal or terminal group, and the requesting terminal or terminal group is enabled to perform the cooperation process.

On the other hand, when the different terminal or terminal group rejects the cooperation request, the terminal 200A requests the coordination server 300 to set a cooperation relation with the rejecting terminal or terminal group (operation S109).

When the coordination server 300 successfully sets the requested cooperation relation (operation S110), the terminal 200A returns to operation S103 and requests the cooperation process again. Otherwise, the terminal 200A performs a task of the terminal and logs out the coordination server 300 (operation S108).

Although only the terminal 200A is described with reference to FIG. 3, the other terminals 200B and 200c operate like the terminal 200A.

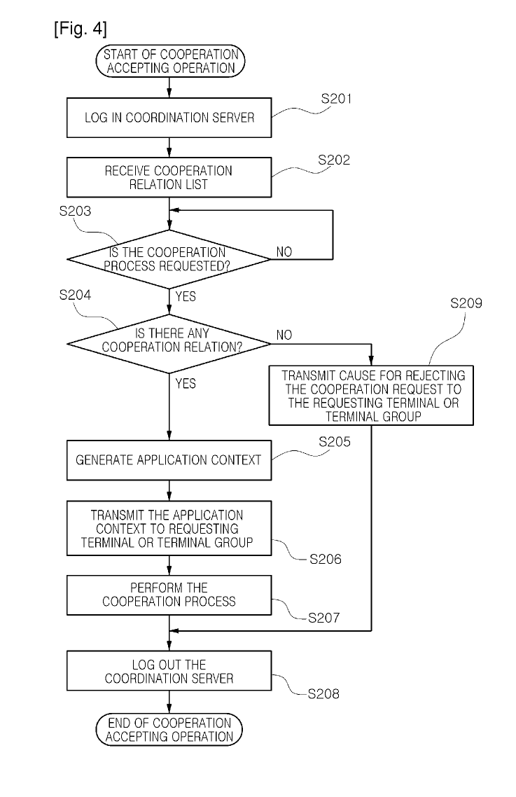

FIG. 4 is a flowchart of a method of accepting a cooperation request using a P2P protocol according to an embodiment of the present invention.

First, the terminal 200A logs in the coordination server 300 (operation S201) and receives a cooperation relation list (operation S202).

In this state, when receiving a cooperation request from the different terminal or terminal group (operation S203), it is checked whether the requesting terminal or terminal group has a cooperation relation with the terminal with reference to the cooperation relation list (operation S204).

When the requesting terminal or terminal group has the cooperation relation to the terminal, a context is extracted from a currently executed application with reference to application list information that is set in the cooperation relation list (operation S205).

The extracted application context is transmitted to the requesting terminal or terminal group (S206), and the cooperation process for the application is performed (operation S207).

In operation S206, when the requesting terminal or part of the terminal group logs out the coordination server 300, the application context is temporarily stored and provided when the requesting terminal or part of the terminal group logs in the coordination server 300.

On the contrary, as a result of operation S203, when the requesting terminal or terminal group has no cooperation relation to the terminal 200A, a terminal 200A transmits a cause for rejecting the cooperation request to the requesting terminal or terminal group (operation S209), performs its own task, and logs out the coordination server 300 (operation S208).

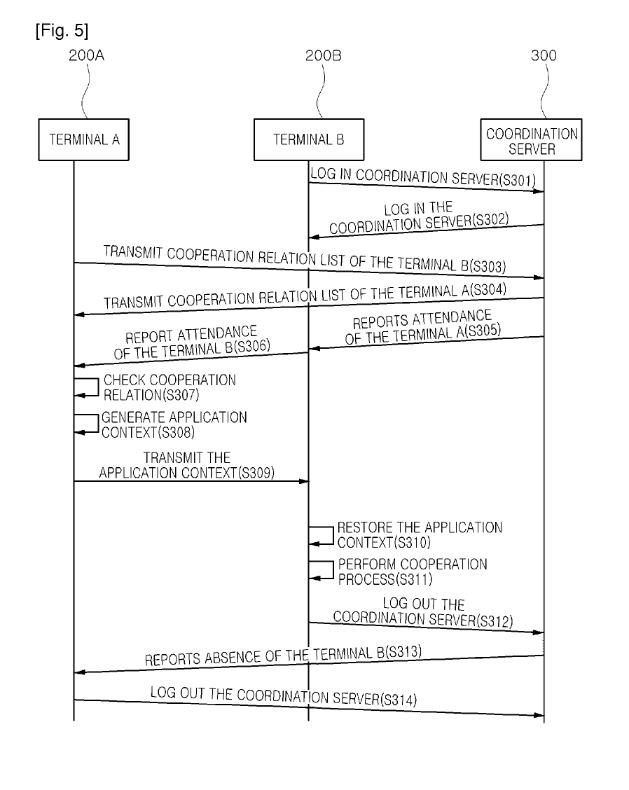

FIG. 5 is a flowchart of a method of cooperating using a P2P protocol among a plurality of terminals which access a coordination server according to an embodiment of the present invention.

In FIG. 5, for the convenience of description, it is assumed that the terminal A 200A and a terminal B 200B have a cooperation relation to each other and that the terminal B 200B request the terminal A 200A to cooperate with the terminal B 200B.

First, when the terminal B 200B logs in the coordination server 300 through the P2P protocol (operation S301), the coordination server 300 connects a communication session with the logged-in terminal B 200B based on session information of the logged-in terminal B 200B and provides a cooperation relation list (operation S302).

In this state, when the terminal A 200A logs in the coordination server 300 through the P2P protocol (operation S303), the coordination server 300 connects the communication session with the terminal A 200A and provides the cooperation relation list to the terminal A 200A (operation S304).

The coordination server 300 recognizes the terminal B 200B having the cooperation relation with the terminal A 200A with reference to the cooperation relation list and reports the attendance of the terminal A 200A to the terminal B 200B (operation S305).

When the terminal B 200B requests the terminal A 200A to cooperate with the terminal B 200B for a specific application (operation S306), the terminal A 200A checks whether the terminal A 200A has a cooperation relation with the terminal B 200B (operation S307). When it is checked that the terminal A 200A has the cooperation relation with the terminal B 200B, the terminal A extracts a context of the application (operation 5308) and transmits the application context to the terminal B (200B) (operation S309).

The terminal B receives and restores the application context provided by the terminal A 200A (operation 5310) and performs a cooperation process based on the restored application context (operation S311).

When the terminal B logs out the coordination server 300 in response to the request of the user while performing the task of its own (operation S312), the coordination server 300 disconnects the communication session with the terminal B 200B and reports the absence of the terminal B 200B to the terminal A 200A (operation S313).

The terminal A 200A logs out the coordination server 300 in response to the report and stops the cooperation process (operation S313).

While the present invention has been particularly shown and described with reference to exemplary embodiments thereof, it will be understood by those skilled in the art that various changes in form and details may be made therein without departing from the spirit and scope of the present invention as defined by the appended claims.

1. A terminal performing a cooperation process through a P2P (peer-to-peer) protocol, the terminal comprising:
a cooperation control unit including a cooperation relation list, requesting a different terminal or terminal group to cooperate with the terminal with reference to the cooperation relation list when a cooperation process is requested, restoring an application context transmitted from the different terminal or terminal group, extracts an application context of the terminal when receiving a cooperation request, and providing the application context of the terminal to the different terminal or terminal group;
an application cooperation execution unit cooperating with the different terminal or terminal group for the application based on the application context restored by the cooperation control unit; and
a P2P communication unit transmitting and receiving the application context in a P2P manner by accessing the different terminal or terminal group.

2. The terminal of claim 1, wherein the application context is operation status information of the application for which the cooperation process is performed.

3. The terminal of claim 2, wherein the cooperation control unit further has a function of extracting the application context of the terminal and providing the application context to the different terminal or terminal group so that the different terminal or terminal group recognizes a progress of the cooperation process, even when the terminal requests the cooperation process.

4. The terminal of claim 1, wherein the cooperation relation list includes information on the different terminal or terminal group having the cooperation relation and information on the application list.

5. The terminal of claim 1, wherein the cooperation control unit further has a function of temporarily storing the application context when the different terminal or terminal group logs out the coordination server and providing the application context when the different terminal or terminal group logs in the coordination server.

6. The terminal of claim 1, wherein the cooperation control unit further has a function of receiving the cooperation relation list from the coordination server.

7. The terminal of claim 6, wherein when the terminal or a part of terminal group logs out the coordination server, the cooperation control unit transmits the application context to the coordination server and provides the application context when the absent terminal or terminal group logs in the coordination server.

8. The terminal of claim 1, wherein the cooperation control unit sets priorities of the cooperation relation of the different terminal or terminal group and firstly extracts and provides the application context, when receiving a cooperation request from the different terminal or terminal group having a high priority.

9. The terminal of claim 1, wherein the cooperation control unit firstly extracts and provides the application context when the different terminal or terminal group having the high priority logs in the coordination server and cooperates by allowing a transmitter to directly access the different terminal or terminal group and restore the application context.

10. The terminal of claim 6, wherein the P2P communication unit further includes: a P2P client receiving and transmitting the application context extracted by the cooperation control unit and transmitted from the different terminal or terminal group to the cooperation control unit; and
a server communication unit communicating with the coordination server through the P2P protocol.

11. A coordination server connected to a plurality of terminals for performing a cooperation process, the coordination server comprising:
a terminal communication unit communicating with the plurality of terminals through a P2P (peer-to-peer) protocol;
a session management unit determining whether the plurality of terminals log in the coordination server and connecting a communication session with the logged-in terminals; and
a cooperation management unit managing a cooperation relation list and providing the cooperation relation list to the logged-in terminals.

12. The coordination server of claim 11, wherein the cooperation relation list includes information on different terminals or terminal groups having a cooperation relation with each terminal and information on an application list.

13. The coordination server of claim 11, further comprising an application context providing unit receiving and storing the application context transmitted from terminals that performs the cooperation process when there is a terminal that logs out the coordination server and providing the application context when the logged-out terminal logs in the coordination server, again.

14. A method of requesting a cooperation process using a P2P (peer-to-peer) protocol in a cooperation system constructed with a coordination server and a plurality of terminals that performs the cooperation process, the method comprising:
allowing a terminal to request a different terminal or terminal group to cooperate with the terminal with reference to a cooperation relation list;
allowing the different terminal or terminal group to receive the application context provided in a P2P manner by accepting the cooperation request; and
performing the cooperation process for the application by restoring the received application context.

15. The method of claim 14, wherein the cooperation relation list includes information on the different terminal or terminal group having a cooperation relation and information on the application list.

16. The method of claim 14, wherein the application context is operation status information of an application for which the cooperation process is performed.

17. The method of claim 14, further comprising setting a cooperation relation with the different terminal or terminal group through the coordination server and reentering the process of requesting the different terminal or terminal group to cooperate with the terminal, when the different terminal or terminal group rejects the cooperation request.

18. The method of claim 14, further comprising allowing the terminal to extract an application context of the terminal and provide the application context to the different terminal or terminal group so as to report a progress of the cooperation process of the terminal to the different terminal or terminal group.

19. A method of accepting a cooperation request using a P2P (peer-to-peer) protocol in a cooperation system constructed with a plurality of terminals that performs a cooperation process, the method comprising:
allowing a terminal to determine whether to accept the cooperation request, when receiving the cooperation request from a different terminal or terminal group; and
allowing the terminal to extract an application context of its own when accepting the cooperation request and provide the application context to the different terminal or terminal group in a P2P manner.

20. The method of claim 19, wherein the cooperation relation list includes information on the different terminal or terminal group having a cooperation relation and information on the application list.

21. The method of claim 19, wherein the application context is operation status information of an application for which the cooperation process is performed.

22. The method of claim 19, further comprising reporting a cause for rejecting the cooperation request to the different terminal or terminal group, when rejecting the cooperation request.

23. The method of claim 19, further comprising storing the application context when the terminal or a part of the terminal group that performs the cooperation application is disconnected and providing the application context when the logged-out terminal or part of the terminal group logs in the coordination server, again.

24. The method of claim 19, further comprising setting priorities of the cooperation relation of the different terminal or terminal group and firstly extracting and providing the application context, when the different terminal or terminal group having a high priority request the cooperation process.

25. The method of claim 19, further comprising setting priorities of the cooperation relation of the different terminal or terminal group and firstly extracting and providing the application context when the different terminal or terminal group having the high priority logs in the coordination server and cooperating by allowing the transmitter to directly access the different terminal or terminal group and restore the application context.
